(19) United States
(12) Patent Application Publication
(10) Pub. No.: US 2008/0056775 A1
(43) Pub. Date: Mar. 6, 2008

(54) Toner and image forming apparatus that uses the toner

(75) Inventor: Toru Ishihara, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Oki Data Corporation, Tokyo (JP)

(21) Appl. No.: 11/847,637

(22) Filed: Aug. 30, 2007

(30) Foreign Application Priority Data
Sep. 4, 2006 (JP) 2006-238650

(51) Int. Cl. G03G 15/08; G03G 9/00

(52) U.S. Cl. 399/284; 430/108.1

(57) ABSTRACT

A toner includes a base toner that contains a binder resin, a colorant, and a wax. The base toner includes at least one endothermic peak specific to the wax in a range of 60 to 100° C., and a total endothermic of not less than 2 mJ/g. The base toner meets a condition expressed by (σ/M)×100≦23 where M is an average particle diameter and σ is a standard deviation of a first population of particle diameters after toner particles having diameters smaller than a certain value have been removed from a second population of the particle diameters, the certain value lying on a smaller side of an average particle diameter of the second population. The toner has a flow-ability of not smaller than 60%. The base toner is blended with at least 0.3 weight parts of a first external additive and at least 0.3 weight parts of a second external additive.

### BACKGROUND OF THE INVENTION

1. Field of the Invention

The present invention relates to toner and an image forming apparatus that uses the toner.

2. Description of the Related Art

A conventional electrophotographic image forming apparatus including a color printer and a color copying machine usually supplies oil to a fixing unit in order to prevent hot offset of an image. Apparatuses of late employ a blend of toner and wax, which eliminates the need for an oil-supplying device. Gloss is often demanded of color images, and therefore color toners are required to have a low melt viscosity necessary for gloss of a print. The demand for high speed printing and high quality image is still growing. For meeting the demands for high speed printing and high quality image, toners having small particle diameters have been intensively developed. High speed, high quality image, and small particle diameter are such that a demand for one factor urges development of another.

For an image forming apparatus (hereinafter oil-free image forming apparatus) in which a fixing unit does not use oil, i.e., an image forming apparatus not provided with a device for supplying oil to the fixing unit, the following are obstacles to high quality image and high speed printing.

Firstly, for an oil-free image forming apparatus, it is desirable to blend toner and wax for preventing hot offset. However, incorporation of wax tends to cause filming on a photoconductor and on a developing blade.

Secondly, a toner having a small particle diameter provides excellent reproducibility of dots, being effective in achieving high quality images. On the other hand, a small particle diameter increases Van der Waals force acting among the toner particles, decreasing the flowability of toner. One way of solving this problem is to add a large amount of an external additive but a large amount of external additive is apt to cause filming on the photoconductor and developing blade.

### SUMMARY OF THE INVENTION

The present invention was made to solve the aforementioned prior art problems.

An object of the invention is to provide a toner suitable for high quality image reproduction and high speed printing using an image forming apparatus in which oil is not involved in a fixing unit.

A toner includes a base toner that contains a binder resin, a colorant, and a wax. The base toner includes at least one endothermic peak specific to the wax in a range of 60 to 100° C., and a total endothermic of not less than 2 mJ/g. The base toner meets a condition expressed by (σ/M)×100≦23 where M is an average particle diameter and σ is a standard deviation of a first population of particle diameters after toner particles having diameters smaller than a certain value have been removed from a second population of the particle diameters, the certain value lying on a smaller side of an average particle diameter of the second population.

The average particle diameter is smaller than 7.0 μm.

The toner includes a flow-ability of not smaller than 60% in terms of toner cohesion. The base toner is blended with at least 0.3 weight parts of a first external additive based on 100 weight parts of the binder resin and at least 0.3 weight parts of a second external additive based on 100 weight parts of the binder resin. The first external additive includes an average primary particle diameter not larger than 40 nm. The second external additive includes an average primary particle diameter not smaller than 40 nm. The sum of an amount of the first external additive and an amount of the second external additive is not smaller than 3.0 weight parts based on 100 weight parts of the binder resin.

An image forming apparatus incorporates the aforementioned toner.

The image forming operates such that a print medium is transported at a print speed of 130 mm/sec or higher.

Further scope of applicability of the present invention will become apparent from the detailed description given hereinafter. However, it should be understood that the detailed description and specific examples, while indicating a preferred embodiment of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates a pertinent portion of an image forming apparatus 1 of an embodiment;

FIG. 2 illustrates a set-up for measuring toner cohesion.

FIGS. 3-5 illustrate the distribution of diameter of toner particles having a mean value M and standard deviation for three different populations of particle diameters;

FIG. 6 lists the properties of EXAMPLE 1 to EXAMPLE 10 and the corresponding test results;

FIG. 7 is a graph illustrating the measurements on 10 mg of toner by using a Perkin-Elmer DSC-7 differential scanning calorimeter; and

FIG. 8 lists the properties of COMPARATIVE EXAMPLE 1 to COMPARATIVE EXAMPLE 10 and the corresponding test results.

### DETAILED DESCRIPTION OF THE INVENTION

### Emodiment

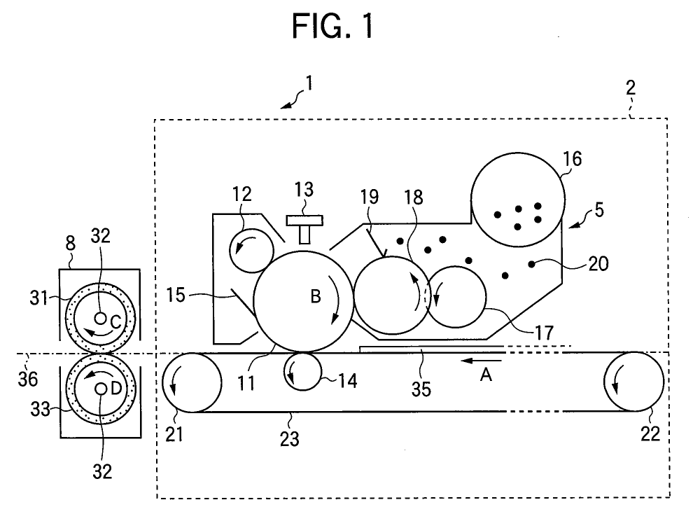

FIG. 1 illustrates a pertinent portion of an image forming apparatus 1 of an embodiment.

Referring to FIG. 1, the image forming apparatus 1 is, for example, an electrophotographic printer that includes image forming sections 2 (only one is shown) and a fixing unit 8. The image forming apparatus 1 includes yellow, magenta, cyan, and black image forming sections 2 in tandem, each section being configured in a similar way. For simplicity, only one of the four image forming sections will be described, it being understood that the remaining image forming sections may work in a similar fashion. The image forming section 2 includes a photoconductive drum 11 around which a charging roller 12, an LED print head 13, a developing section 5, a transfer roller 14, and a cleaning blade 15 are disposed from upstream to downstream with respect to rotation of the photoconductive drum 11. A transfer belt 23 is sandwiched between the photoconductive drum 11 and the transfer roller 14, and runs with a print medium placed thereon. The transfer belt is entrained about drive rollers 21 and 22.

The photoconductive drum 11 includes a drum-shaped conductor formed of, for example, aluminum, covered with a layer of a photoconductive material. The photoconductive drum 11 is driven by a drive source (not shown) in rotation in a direction shown by arrow B. The charging roller 12 rotates in contact with the photoconductive drum 11. The LED print head 13 includes a plurality of LEDs that emit light and a lens array that focuses the light emitted from the LEDs on the charged surface of the photoconductive drum 11 to form an electrostatic latent image.

The developing unit 5 includes a developing roller 18 that bears a layer of toner thereon, a sponge roller 17 that supplies the toner to the developing roller 18, a developing blade 19 that forms the layer of toner on the developing roller 18, and a toner cartridge 16 that holds the toner therein. The toner cartridge 16 supplies toner into a toner chamber. The developing roller 18 rotates in contact with the photoconductive drum 11, so that the layer of toner is brought into contact with the electrostatic latent image on the photoconductive drum 11. In other words, the developing roller 18 supplies the toner to the electrostatic latent image formed on the photoconductive drum, thereby developing the electrostatic latent image into a toner image.

The transfer roller 14 transfers the toner image onto a print medium 35 placed on the transfer belt 23. The cleaning blade 19 is formed of, for example, urethane rubber, and scrapes the residual toner 20 off the photoconductive drum 11. The charging roller 12, developing roller 18, and transfer roller 14 rotate in contact with the photoconductive drum 11. The developing roller 18 rotates in contact with the developing blade 19 and the sponge roller 17.

The fixing unit 8 is disposed downstream of the image forming sections 2 aligned along a transport path 36 in which the print medium 36 is advanced in a direction shown by arrow A. The fixing unit 8 includes a heat roller 31, a back-up roller 33, and halogen lamps 32 built in the heat roller 31 and the back-up roller 33. The heat roller 31 is in the shape of a hollow cylinder of aluminum coated with a fluorinated material such as Perfluoro alkoxyl alkane (PFA) or polytetrafluoroethylene (PTFE). The back-up roller 33 is a resilient roller. The heat roller 31 and back-up roller 33 are in pressure contact with each other.

Gears (not shown) are mounted to the rollers and drums except the back-up roller 33, being press-fitted or by some other means. A drum gear, a developing roller gear, a sponge roller gear, a transfer roller gear, and a charging roller gear drive the photoconductive drum 11, developing roller 18, sponge roller 17, transfer roller 14, and charging roller 12, respectively.

Power supplies (not shown) supply bias voltages to the charging roller 12, developing roller 18, sponge roller 17, transfer roller 14, and LED print head 13, and halogen lamps 32 of the fixing unit 8, respectively. The power supplies are high voltage sources of well known types, and operate under the control of a controller (not shown).

The toner 20 will be described. The toner 20 is held in the toner cartridge 16 of the developing unit 5.

In order to achieve a fine balance among oil-free fixing operation, high quality images, and high speed printing, the following requirements should be fulfilled.

In order to prevent hot offset, it is desirable for the toner to contain a certain amount of wax for preventing hot offset. However, incorporating a large amount of wax tends to cause “filming” on the photoconductive drum and developing blade.

A small-diameter toner is generally advantageous to achieve high quality images. However, small-diameter particles are subjected to large Van der Waals forces that cause poor flow-ability of toner particles. In order for small-diameter toner particles to have adequate flow-ability required to achieve good dot reproducibility, the inventor discovered that flow-ability should be equal to or larger than 50%, more preferably equal to or larger than 60%, measured in terms of toner cohesion. This is the equivalent of an external additive not less than 2.5 by weight percent (wt %) and preferably not less than 3.0 by weight percent based on the base toner. This is quite a large amount for the external additive. Such a large amount of external additive tends to cause filming on the photoconductive drum and the developing blade.

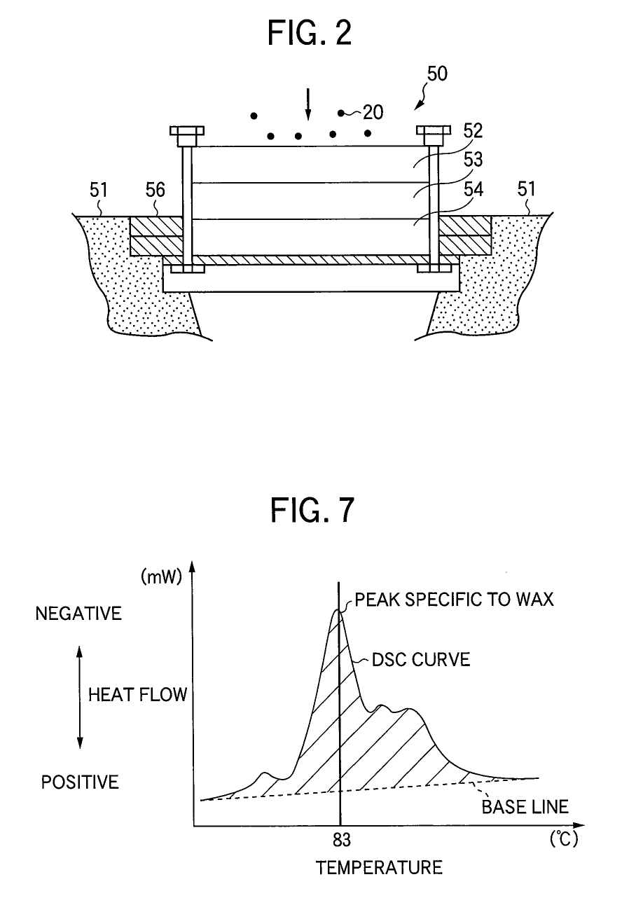

FIG. 2 illustrates a set-up for measuring toner cohesion. Toner flow properties are most conveniently quantified by measurement of toner cohesion. One standardized procedure follows the following protocol and may be performed using a Hosokawa Powders Tester (Model PT-N, available from Micron Powders Systems):

1) place a known mass of fresh toner, for example 4.0 grams, on top of a set of three screens 54, 53, and 52 with screen meshes of 45 microns, 75 microns, and 150 microns, respectively, in order from bottom to top, and then place the set of three screens on a vibrator 51;

2) vibrate the screens and toner for a fixed time at a fixed vibration amplitude, for example for 15 seconds at a 1 millimeter vibration amplitude;

3) Measure the amount of toner remaining on each of the screens 54, 53, and 52 at the end of the vibration period.

Then, the weight of toner on each screen was measured, and the flow-ability of the toner was calculated using the following equation.

Z={(weight of toner on screen 52)/4.0}×100{(weight of toner on screen 53)/4.0}×(3/5)×100{(weight of toner on screen 54)/4.0}×(1/5)×100

Flow-ability(%)=100−Z

The same measurement was performed three times, and an average value was employed as the flow-ability of the toner. Z is referred to as cohesion.

The inventor investigated the aforementioned problems such as offset, filming, and particle diameter as follows. {Filming on a Developing Blade and Photoconductive Drum} The inventor found the following facts. The filming on a developing blade and the filming on a photoconductive drum are caused by the same mechanism. External additives for the toner used in an electrophotographic printer include silica and titania. An external additive first adheres to the surface of a photoconductive drum (Photoconductive drum 18 in FIG. 1). Then, a base toner containing a resin material, a colorant, and a wax melts on the surface of the photoconductive drum, subsequently adhering to the surface.

The following facts account for the aforementioned mechanism. After performing printing, the inventor observed the surface of the developing blade and the photoconductive drum with a scanning electron microscope (SEM), and found a large amount of the external additive on the surface. An elemental analysis and an infrared absorption spectrometry (IR) revealed that the ratio of the peak intensity of carbon atom to that of silicon atom (when external additive is silica) is dozens of times the ratio obtained from a toner used for this experiment. A relatively large amount of base toner was observed on the outermost layer of the filming formed on the developing blade but only silica was observed in a portion of the layer in direct contact with the developing blade. Likewise, only silica was observed in a portion of the layer in direct contact with the photoconductive drum and the developing blade.

Another experiment was performed using a toner with no external additive added thereon. No filming was observed when printing was performed on 30,000 pages of paper. This result confirms that an external additive was involved in filming. As is expected, however, a toner having no external additive exhibited poor flow-ability, so that reproducibility of dot was poor and therefore only light or vague solid images were printed.

The inventor also investigated the relation between wax and filming. A toner contained 5 weight parts carnauba wax having a melt point of 83° C. An additive in an amount of 4 weight parts was added to the toner. When printing was performed on 1000 pages of paper, filming was observed on the photoconductive drum and the developing blade. Another toner contained the same carnauba wax in an amount of 0.5 weight parts. Filming did not occur on the photoconductive drum and the developing blade when printing was performed on 30,000 pages of paper. The test results tell us a filming mechanism in which the additive first adheres to the surfaces of the photoconductive drum and developing blade to form a first layer, and subsequently the base toner containing wax, which is easy to melt, is caught by the first layer, and finally melts due to friction heat. It is to be noted that the toner containing 0.5 weight parts wax exhibited poor hot-offset performance and therefore continuous printing could not be performed without supplying oil to the fixing unit (fixing unit 8 in FIG. 1).

### {Particle Diameter, Distribution of Particle Diameter, and Filming}

The inventor also investigated the relation among particle diameter, distribution of particle diameter, and filming.

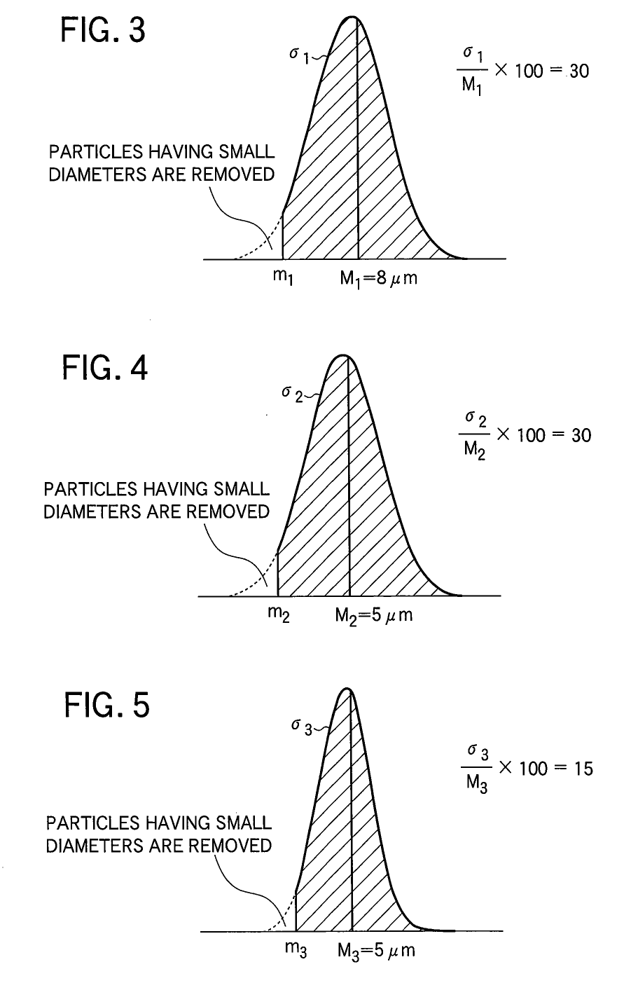

FIGS. 3-5 illustrate the distribution of diameter of toner particles having a mean value M and standard deviation for three different populations of particle diameters.

Referring to FIGS. 3-5, a hatched area represents a first population of particle diameters of the toner. The first population is obtained by removing toner particles that represents a portion (white area) in the vicinity of the lower limit of the distribution of a second population (bell-shaped area). The portion in the vicinity of the lower limit is defined by an area bounded by the probability distribution curve and a line passing through points m1, m2, or m3. M is a mean particle diameter and σ is a standard deviation of the first population of particle diameters. The quantity σ/M is the ratio of the standard deviation σ of particle diameters to the mean particle diameter M.

Printing was performed using a toner (FIG. 3) having a value of (σ1/M1)×100=30 where M1 (M1=8 μm) is a mean particle diameter and al is a standard deviation of particle diameter indicative of variation of diameter of toner particles.

Printing was also performed using a toner (FIG. 4) having a value of (σ2/M2)×100=30 where M is 5 μm. Filming occurred after printing 3000 pages of paper. The inventor considers that this filming is due to the fact that small particles have a small heat capacity and is therefore easy to melt.

The inventor expected that reducing the number of particles having smaller diameters would minimize filming, and prepared a toner (FIG. 5) having a value of (σ3/M3)×100=15 where M3 is film). It is to be noted that the distribution in FIG. 5 is tighter than those shown in FIGS. 3 and 5. Printing was performed using this toner. Filming did not occur when printing was performed on 30,000 pages of paper. This reveals that a toner should have a narrow range of variation of particle diameter, i.e., a narrow shape of the profile of distribution of particle diameters.

The aforementioned results of experiment can be summarized as follows:

(1) A toner that may be used in an oil-free fixing unit requires incorporation of wax as a toner release agent. However, incorporation of wax tends to cause filming on a photoconductive drum and a developing roller.

(2) For excellent dot reproducibility, toner should have small particle diameters and high flow-ability. However, toners having small particle diameters are difficult to ensure good flow-ability as opposed to those having large particle diameters. One way of improving flow-ability of toner particles is to add a large amount of external additive such as silica or titania. However, adding a large amount of external additive may improve flow-ability of toner particles but tends to cause filming.

### {Optimum Conditions Required of Printer}

In order to determine optimum conditions required of the printer, the inventor conducted experiment using a toner that contains a wax. The inventor expected that one component development method is effective in achieving a fine balance among oil-free fixing, high quality images, and high speed printing. Simple construction is an excellent advantage of a printer of one component development method. Because one component toner does not need carrier beads, a printer of one component development method has an advantage of easy maintenance. However, the amount of toner deposited to a developing roller is smaller in a one-component development method than in a two-component development method. In other words, a layer of toner formed on a developing roller is thinner for one component toner than for two component toner. Therefore, one component toner receives more stress than two component toner, causing filming on the developing blade.

From above-described investigation, an optimum amount of toner deposited on a developing roller is preferably in the range of 0.3-0.9 mg/cm². A thickness of toner layer not larger than 0.3 mg/cm² not only fails to provide a sufficient density of image but also is unable to withstand stress so that filming occurs on the developing blade. A thickness not smaller than 0.9 mg/cm² is difficult to maintain and becomes unstable during continuous printing, being difficult to obtain stable printing density.

A specific factor that determines the thickness of a toner layer is the line pressure applied to the developing roller 18 by the developing blade 19 (FIG. 1). The line pressure is preferably in the range of 1.0 to 10.0 g/mm.

The inventor also investigated the relation between toner and printing speed. Generally speaking, the toner is subjected to mechanical stress and thermal stress when the toner is triboelectrically charged. The higher the printing speed becomes, the larger the mechanical stress and thermal stress become. The inventor confirmed this fact in his investigation toward the present invention. With high speed printing is performed in the one component development method, the toner according to the present invention is highly filming resistant as opposed to the conventional toners.

In some cases, conventional toners did not cause filming at low speed printing. This fact shows that the toner according to the present invention is particularly useful in high speed printing. Specifically, the usefulness of the toner according to the invention was prominent at printing speeds (i.e., circumferential speed of a photoconductive drum 11) higher than 130 mm/sec. This printing speed is equivalent to a circumferential speed of the photoconductive drum.

The toner and the printer according to the invention will be described in more detail by way of examples and comparative examples.

The operation of the image forming apparatus 1 will be described with reference to FIG. 1. Upon a print command received from a controller (not shown), a motor (not shown) begins to rotate. The drive force of the motor is transmitted via several gears to the drum gear, and drives the photoconductive drum 11 in rotation. The drive force is further transmitted from the drum gear to the developing roller gear to rotate the developing roller 18. The drive force is then transmitted from the developing roller gear to the sponge roller gear via an idle gear, thereby driving the sponge roller 17 in rotation.

The drive force is transmitted from the drum gear to the charging roller to drive the charging roller 12 in rotation. The drive force is transmitted from the drum gear to the transfer roller gear to drive the transfer roller 14 in rotation. The drive force of the motor is also transmitted to the heat roller gear via a train of gears so that the heat roller 31 rotates in a direction shown by arrow C. The back-up roller 33 rotates in a direction shown by arrow D in contact with the heat roller 31 due to the frictional force between the heat roller 31 and the back-up roller 33.

Substantially at the same time that the motor begins to rotate, power supplies (not shown) supply bias voltages to the respective rollers of the image forming section 2 and a voltage to the halogen lamps 32 of the fixing unit 8. The charging roller 12 receives a voltage from a corresponding power supply and uniformly charges the circumferential surface of the photoconductive drum 11. As the charged surface of the photoconductive drum 11 rotates past the LED print head 13, the LED print head 11 illuminates the charged surface of the photoconductive drum 11 in accordance with a print image to form an electrostatic latent image. As the photoconductive drum 11 rotates, the electrostatic latent image rotates into contact with the developing roller 18. The toner in the form of a thin layer formed on the developing roller 18 is brought into contact with the electrostatic latent image, thereby developing the electrostatic latent image into a toner image.

The toner image formed on the photoconductive drum 11 is then transferred by the transfer roller 14 onto a print medium 35. Then, the print medium 35 passes through a fixing point defined between the heat roller 31 and the back-up roller 33 so that the toner image on the print medium 35 is fused under heat and pressure into a permanent image. A cleaning blade 15 scrapes residual toner off the photoconductive drum 11 after transfer, and is collected into a waste toner chamber.

### EXAMPLES

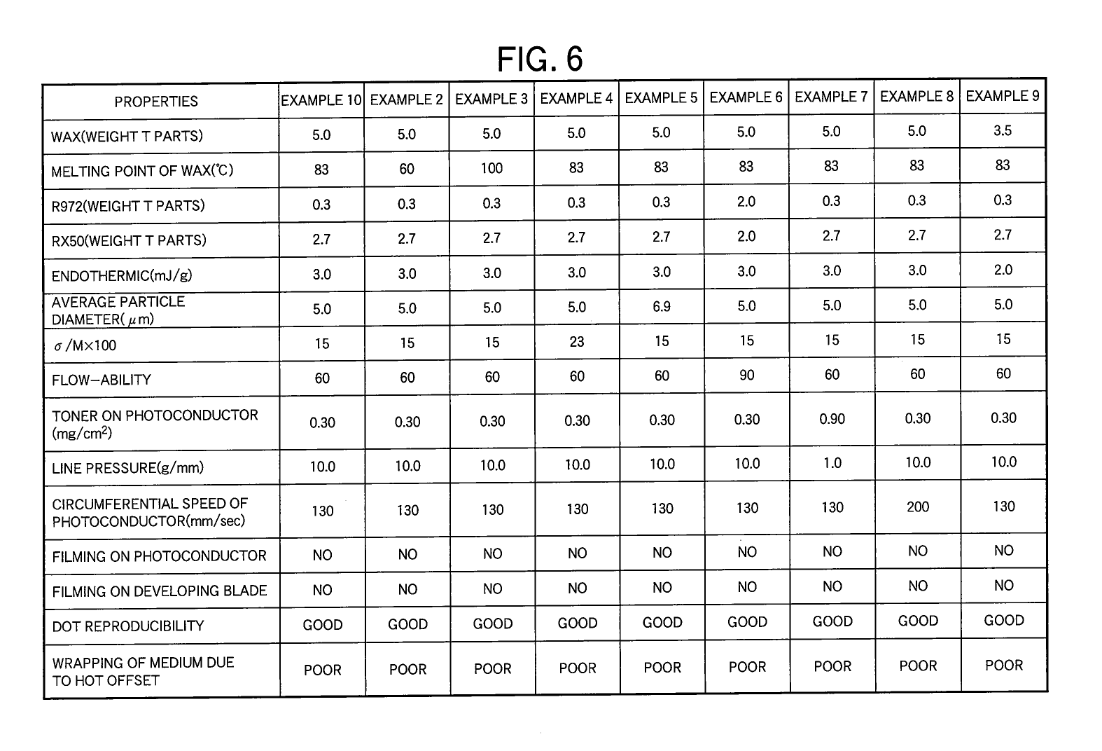

Examples E1-E10 of toner and comparative examples C1-C10 of toner were prepared and experiment was conducted using these toners and the image forming apparatus 1. FIG. 6 lists the properties of EXAMPLE 1 to EXAMPLE 10 and the corresponding test results.

### Example 1

The following materials were placed in a Henschel Mixer: 100 weight parts of polyester resin (number molecule average molecular weight Mn=3700, glass transition temperature Tg=62° C. as a binder resin) as a binder resin; 5.0 weight parts of carnauba wax (melting point 83° C. equal to an endothermic peak temperature specific to wax); 4.5 weight parts of phthalocyanine blue (colorant); and 2.5 weight parts of a charge control agent.

The materials were then agitated and sufficiently mixed in a Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of hydrophobic silica powder RX50 (available from Aerosil Japan, average primary particle diameter 45 nm), thereby obtaining a final toner having an average particle diameter M=5.0 μm and a value of (σ/M)×100=15. R-972 and RX50 were used as an external additive. The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak of this toner was 83° C., which is specific to carnauba wax. The total endothermic energy (adsorption of heat) of the base toner including endothermic energy specific to remaining compositions was 3.0 mJ/g.

The endothermic energy and endothermic peaks will be described.

FIG. 7 is a graph illustrating the measurements on the above-mentioned 10 mg of toner by using the Perkin-Elmer DSC-7 differential scanning calorimeter. Because the toner contains many compositions, more than one peak appears and the endothermic peak specific to the wax is the largest of all. A base line is drawn as shown in FIG. 7, and the total amount of endothermic energy of the base toner may be calculated from the area (hatched area) bounded by the DSC curve and the base line.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of A4 XEROX 4200 paper at a printing duty of 5%. After the continuous printing, a visual inspection was performed on the surface of the photoconductive drum 11. Observation was also made with an SEM. No filming due to firm deposition of the toner and external additive was observed. Likewise, visual inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1 is reached.

### Example 2

The following materials were placed in a Henschel Mixer: 100 weight parts of polyester resin (number molecule average molecular weight Mn=3700, glass transition temperature Tg=62° C.) as a binder resin; 5.0 weight parts of paraffin wax (melting point 60° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using the Perkin-Elmer DSC-7 differential scanning calorimeter at a rate of 80° C./min. The endothermic peak temperature of this toner was 60° C., which is specific to paraffin wax. The total endothermic energy (adsorption of heat) of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller 18 by the developing blade 19 was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, visual inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 3

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 100° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 100° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade 19 was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was made on the surface of the photoconductive drum 11. Observation was also made with an SEM. No filming due to firm deposition of the toner and external additive was observed. Likewise, inspection and SEM observation were made on the developing blade 19 in contact with the developing roller 18, and no filming due to deposition of melted toner was observed. No abnormal result due to filming on the photoconductive drum and developing blade was noticed in printed images. Good dot reproducibility was maintained until the end of the usable life of the image forming apparatus 1.

### Example 4

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=23. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, visual inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 5

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=6.9 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, visual inspection and SEM observation were made on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 6

The following materials were placed in a Henschel Mixer: 100 weight parts of polyester resin (number molecule average molecular weight Mn=3700, glass transition temperature Tg=62° C.) as a binder resin; 5.0 weight parts of canauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 2.0 weight parts of hydrophobic silica powder (Aerosil R-972, available from Aerosil Japan, average primary particle diameter 8 nm) and 2.0 weight parts of RX50 (available from Aerosil Japan, 45 nm), thereby obtaining a final toner having an average particle diameter M=5.0 μm and a value of (σ/M)×100=15. R-972 and RX50 were used as an external additive.

The flow-ability of the final toner was 90%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 7

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 1.0 g/mm, and the amount of toner deposited on the photoconductive drum 11 was 0.9 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 8

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to paraffin wax. The total endothermic energy of the base toner including endothermic energies specific to remaining compositions was 3.0 mJ/g.

The toner was placed in the image forming apparatus 1 of FIG. 1, and the printing speed was set to 200 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

### Example 9

The following materials were placed in a Henschel Mixer: 100 weight parts of polyester resin (number molecule average molecular weight Mn=3700, glass transition temperature Tg=62° C.) as a binder resin; 3.5 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 2.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 110 to 190° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, visual inspection and SEM observation were performed on the developing blade 19 in contact with the developing roller 18 and no filming due to deposition of melted toner was observed. No abnormal result due to filming on the photoconductive drum and developing blade was noticed in printed images. Good dot reproducibility was maintained until the end of the usable life of the image forming apparatus 1.

In EXAMPLE 1 to EXAMPLE 9, RX50 (available from Aerosil Japan, average primary particle diameter 45 nm) in an amount of at least 0.3 weight parts should be enough to obtain final toners.

### Comparative Examples

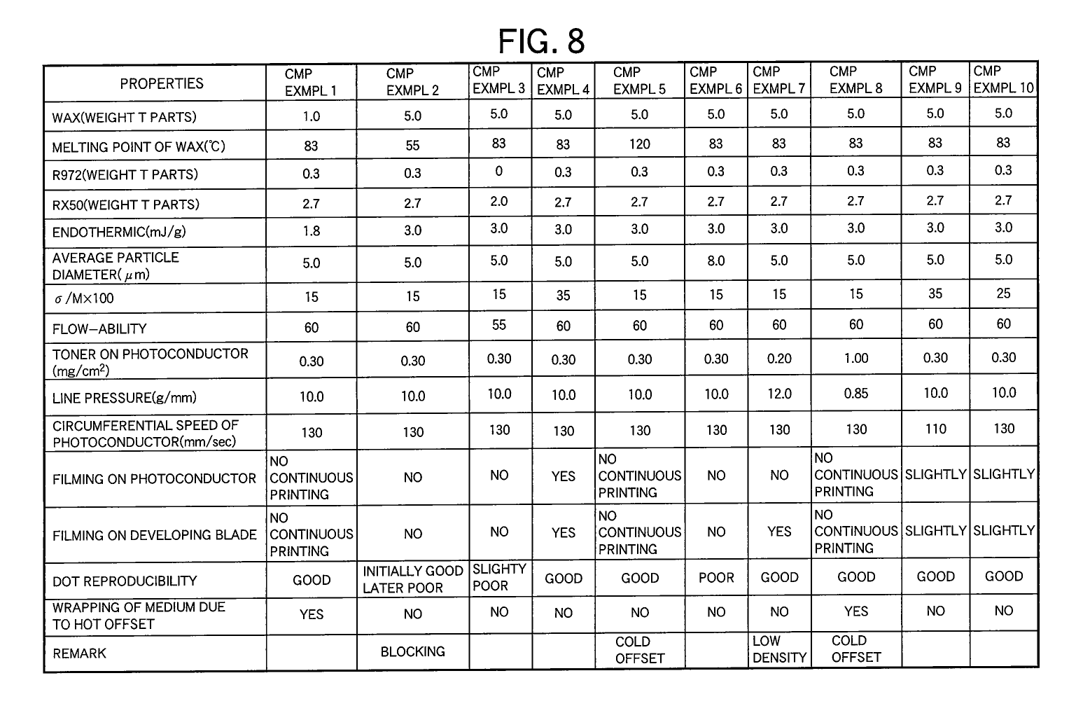

FIG. 8 lists the properties of COMPARATIVE EXAMPLE 1 to COMPARATIVE EXAMPLE 10 and the corresponding test results. Comparative examples will be described with reference to FIG. 5.

### Comparative Example 1

The following materials were placed in a Henschel Mixer: 100 weight parts of polyester resin (number molecule average molecular weight Mn=3700, glass transition temperature Tg=62° C.) as a binder resin; 1.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 1.8 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a narrow temperature range of 140 to 170° C., and that wrapping of print medium around the heat roller due to hot offset sometimes occurred. Therefore, continuous printing was not performed. The inventor considers that this is due to the fact that an insufficient mount of wax shows insufficient effect as a toner release agent. There is a correlation such that a small amount of wax causes a small endothermic energy of the toner. In other words, endothermic energy may be used as an indicator or measure of the amount of wax in the toner.

### Comparative Example 2

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 55° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 55° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 80 to 190° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 15,000 pages of paper. The flow-ability of the toner decreased prominently and dot reproducibility was initially good but deteriorated. The toner was taken out of the developing unit 5 and was examined. “Blocking” had occurred where part of the toner particles melted and caused toner particles to coalesce. The inventor considers that this is due to the fact that low-melting point wax cannot withstand stress during continuous printing.

### Comparative Example 3

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 2.0 weight parts of RX50 (available from Aerosil Japan, average primary particle diameter 45 nm), thereby obtaining a final toner having an average particle diameter M=5.0 μm and a value of (σ/M)×100=15. RX50 is used as an external additive.

The flow-ability of the final toner was 55%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, inspection and SEM observation were performed on the developing blade 19 in contact with the developing roller 18 and no filming due to deposition of melted toner was observed. No abnormal result due to filming on the photoconductive drum and developing blade was noticed in printed images. Somewhat poor dot reproducibility was obtained from the beginning to the end of the usable life of the image forming apparatus 1.

### Comparative Example 4

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 5.0 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=35. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed. After printing 5,000 pages, an abnormal result due to filming on the photoconductive drum and developing blade was noticed in printed images. In fact, SEM observation revealed that melted toner was deposited on the photoconductive drum 11 and a portion of the developing blade 19 in contact with the developing roller 18.

### Comparative Example 5

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 120° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 120° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. The line pressure applied to the developing roller by the developing blade was 10.0 g/mm. Solid printing was performed in a printable area of XEROX 4200 paper. Visual inspection revealed that cold offset occurred at a relatively high temperature (150° C.). Therefore, continuous printing was not performed.

### Comparative Example 6

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=8.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in a very wide temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed on 30,000 pages of paper. After the continuous printing, a visual inspection was performed on the surface of the photoconductive drum 11. Observation was also made with an SEM. No filming due to firm deposition of the toner and external additive was observed. Likewise, inspection and SEM observation were performed on the developing blade 19 in contact with the developing roller 18 and no filming due to deposition of melted toner was observed. No abnormal result due to filming on the photoconductive drum and developing blade was noticed in printed images. However, poor dot reproducibility was obtained from the beginning to the end of the usable life of the image forming apparatus 1.

### Comparative Example 7

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in the temperature range of 100 to 200° C., and that no wrapping of print medium around the heat roller due to hot offset occurred. The line pressure applied to the developing roller by the developing blade was 12.0 g/mm, and the amount of toner deposited on the photoconductive drum 11 was 0.2 mg/cm².

Under the aforementioned conditions, continuous printing was performed. After printing 5,000 pages, an abnormal result due to filming on the photoconductive drum and developing blade was observed in printed images. In fact, SEM observation revealed that melted toner was deposited on the photoconductive drum 11 and a portion of the developing blade 19 in contact with the developing roller 18. The print density was 0.9 in terms of OD value (optical density), lower than an initial value.

### Comparative Example 8

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=15. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. The line pressure applied to the developing roller by the developing blade was 0.85 g/mm. The amount of toner deposited to the photoconductive drum was 1.0 mg/cm². With this condition, solid printing was performed in a printable area of XEROX 4200 paper. Visual inspection revealed that no hot offset occurred in the temperature range of 150 to 170° C. Therefore, continuous printing was not performed. Prominent curling of the printed paper occurred. The inventor considers that this curling is due to an excess amount of toner deposited onto the print medium.

### Comparative Example 9

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 am and a value of (σ/M)×100=35. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 110 mm/sec, somewhat low speed. Solid printing was performed in a printable area of XEROX 4200 paper. Visual inspection revealed that no hot offset occurred in the temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed. After printing 30,000 pages, some abnormal results due to filming on the photoconductive drum and developing blade were observed in printed images. In fact, SEM observation revealed that a negligible amount of melted toner was deposited on the photoconductive drum 11 and a portion of the developing blade 19 in contact with the developing roller 18.

The comparison of the result with that of COMPARATIVE EXAMPLE 4 reveals that even if the toner contains a large amount of fine particles, filming is difficult to occur at low printing speed. In other words, low printing speed may be one way of preventing filming. However, a printer that operates at low printing speed with no filming problem is not so attractive from a practical point of view.

### Comparative Example 10

The following materials were placed in a Henschel Mixer: 100 weight parts of polyester resin (number molecule average molecular weight Mn=3700, glass transition temperature Tg=62° C.) as a binder resin; 5.0 weight parts of carnauba wax (melting point 83° C.); 4.5 weight parts of phthalocyanine blue (colorant); and 2.5 weight parts of a charge control agent.

The materials were then agitated and sufficiently mixed in the Henschel Mixer.

The mixture was heated at 120° C. to melt in a roll mill for approximately 3 hours, and was then cooled to room temperature. The kneaded material was pulverized to a powder, and was subsequently classified into a base toner. The base toner was then blended with a mixture of 0.30 weight parts of hydrophobic silica powder (Aerosil R-972, available from Aerosil Japan, average primary particle diameter 8 nm) and 2.7 weight parts of RX50 (available from Aerosil Japan, average primary particle diameter 45 nm), thereby obtaining a final toner having an average particle diameter M=5.0 μm and a value of (σ/M)×100=27. R-972 and RX50 were used as an external additive.

The flow-ability of the final toner was 60%, measured in terms of toner cohesion.

A measurement was made of 10 mg of this toner by using a Perkin-Elmer DSC-7 differential scanning calorimeter at a rate of 80° C./min. The endothermic peak temperature of this toner was 83° C., which is specific to carnauba wax. The total endothermic energy of the base toner including endothermic energies specific to remaining compositions was 3.0 mJ/g.

The toner was placed in the image forming apparatus 1 of FIG. 1, and the printing speed was set to 130 mm/sec. Solid printing was performed in a printable area of XEROX 4200 paper. Visual inspection revealed that no hot offset occurred in the temperature range of 100 to 200° C., and that no wrapping of print medium around the heat roller due to hot offset occurred. The line pressure applied to the developing roller by the developing blade was 10.0 g/mm, and the amount of toner deposited on the photoconductive drum 11 was 0.3 mg/cm².

Under the aforementioned conditions, continuous printing was performed. After printing 30,000 pages, some abnormal result due to filming on the photoconductive drum and developing blade was observed in printed images. In fact, SEM observation revealed that a negligible amount of melted toner was deposited on the photoconductive drum 11 and a portion of the developing blade 19 in contact with the developing roller 18.

The test results of EXAMPLEs 2, 3, and 9, and COMPARATIVE EXAMPLEs 1, 2, and 5 reveal that both hot offset and endurance are excellent for base toners having more than one endothermic peak specific to a wax in the range of 60 to 100° C. and having an endothermic energy of greater than 2 mJ/g. Thus, from the test results of EXAMPLEs 2, 3, and 9, and COMPARATIVE EXAMPLEs 1, 2, and 5, the inventor concluded that a toner having a value of (σ/M)×100≦23 does not cause filming and therefore exhibits high endurance.

The test results of EXAMPLE 1 and COMPARATIVE EXAMPLE 6 show that a toner having an average particle diameter M (μm) of M<7.0 μm provides excellent dot reproducibility.

The test results of EXAMPLE 1, EXAMPLE 6, and COMPARATIVE EXAMPLE 3 reveal that the following toner provides excellent dot reproducibility.

(1) Flow-ability is greater than 60%.

(2) The base toner is blended with a mixture of 0.30 or more weight parts of an external additive having an average primary particle diameter not larger than 40 nm and 0.3 or more weight parts of an external additive having an average primary particle diameter not smaller than 40 nm, a total amount of external additives being not smaller than 3.0 weight parts based on the base toner.

The test results of EXAMPLEs 1 and 7, and COMPARATIVE EXAMPLEs 7 and 8 reveal that an image forming apparatus should operate under one of two conditions (1) and (2): (1) the amount of toner deposited on the photoconductive drum is preferably in the range of 0.3 to 0.9 mg/cm², and (2) the line pressure of the developing blade exerted on the developing roller is preferably in the range of 1.0 to 10.0 mg/mm.

The test results of EXAMPLEs 1 and 8, and COMPARATIVE EXAMPLE 9 reveal that the toner according to the present invention is most effective when the photoconductive drum 11 rotates at a printing speed of 130 mm/sec or higher.

Despite the fact that wax is incorporated, toners of the invention minimizes the occurrence of hot offset and filming, so that the toners are effective in achieving high quality image and high speed printing.

While the invention has been described with respect to an electrophotographic printer, the invention may also be applicable to facsimile machines, copying machines, and the like.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A toner including a base toner that contains a binder resin, a colorant, and a wax, wherein the base toner comprising:
at least one endothermic peak specific to the wax in a range of 60 to 100° C.; and
a total endothermic of not less than 2 mJ/g;
wherein the base toner meets a condition expressed by,
(σ/M)×100≦23
where M is an average particle diameter and σ is a standard deviation of a first population of particle diameters after toner particles having diameters smaller than a certain value have been removed from a second population of the particle diameters, the certain value lying on a smaller side of an average particle diameter of the second population.

2. The toner according to claim 1, wherein the average particle diameter is smaller than 7.0 μm.

3. The toner according to claim 1, wherein the toner includes a flow-ability of not smaller than 60% in terms of toner cohesion;
wherein the base toner is blended with at least 0.3 weight parts of a first external additive based on 100 weight parts of the binder resin and at least 0.3 weight parts of a second external additive based on 100 weight parts of the binder resin, the first external additive including an average primary particle diameter not larger than 40 nm and the second external additive including an average primary particle diameter not smaller than 40 nm, a sum of an amount of the first external additive and an amount of the second external additive being not smaller than 3.0 weight parts based on 100 weight parts of the binder resin.

4. An image forming apparatus incorporating said toner according to claim 1, comprising:
an image bearing body on which an electrostatic latent image is formed; and
a developing section that supplies the toner to the electrostatic latent image to develop the electrostatic latent image into a toner image;
wherein the developing section supplies the toner in an amount of 0.3 to 0.9 mg/cm² to the electrostatic latent image.

5. An image forming apparatus incorporating said toner according to claim 1, comprising:
an image bearing body on which an electrostatic latent image is formed;
a developing section that supplies the toner to the electrostatic latent image to develop the electrostatic latent image into a toner image;
wherein the developing section includes a developing roller that holds a thin layer of the toner thereon; and
a developing blade in pressure contact with the developing roller and forming the thin layer of the toner on the developing roller, the developing blade applying a line pressure in the range of 1.0 to 10.0 g/mm.

6. The image forming apparatus according to claim 6, wherein the image bearing body operates such that a print medium is transported at a print speed of 130 mm/sec or higher.
